(19) United States
(12) Patent Application Publication
(10) Pub. No.: US 2024/0362445 A1
(43) Pub. Date: Oct. 31, 2024

(54) PRINTING APPARATUS, PRINTING METHOD, AND NON-TRANSISTORY COMPUTER-READABLE RECORDING MEDIUM CONTAINING COMPUTER-EXECUTABLE INSTRUCTIONS THEREFOR

(71) Applicant: BROTHER KOGYO KABUSHIKI KAISHA, Nagoya (JP)

(72) Inventor: Hajime USAMI, Nagoya (JP)

(73) Assignee: BROTHER KOGYO KABUSHIKI KAISHA, Nagoya (JP)

(21) Appl. No.: 18/647,110

(22) Filed: Apr. 26, 2024

(30) Foreign Application Priority Data
Apr. 28, 2023 (JP) 2023-074782

(51) Int. Cl. G06K 15/02; B41J 2/045; B41J 2/21; G06K 15/10

(52) U.S. Cl. CPC G06K 15/1898; B41J 2/04541; B41J 2/04586; B41J 2/2103; G06K 15/102

(57) ABSTRACT

A printing apparatus includes a main controlling circuit, a sub-controlling circuit group including first-n-th sub-controlling circuits connected in series, a head group configured to eject liquid, a first communication path configured to connect the main controlling circuit and the first sub-controlling circuit, and a second communication path configured to connect the main controlling circuit and the n-th sub-controlling circuit. When the main controlling circuit transmit first print data to the first sub-controlling circuit, the sub-controlling circuit group transfers the first print data in a forward direction. When the main controlling circuit transmit second print data to the n-th sub-controlling circuit, the sub-controlling circuit group transfers the second print data in a reverse direction.

### REFERENCE TO RELATED APPLICATIONS

This application claims priority from Japanese Patent Application No. 2023-074782 filed on Apr. 28, 2023. The entire content of the priority application is incorporated herein by reference.

### BACKGROUND ART

The present disclosure relates to a printing apparatus configured to perform printing by ejecting liquid through nozzles provided thereto, a printing method for such a printing apparatus, and a non-transitory computer-readable recording medium containing computer-executable instructions realizing such a method.

There has been suggested a liquid ejecting device configured such that multiple liquid ejecting heads are connected in series. It is noted that an example of such a liquid ejecting device is a print engine of an inkjet printer. In such a device, print data is transmitted from a controller to the most upstream one of the connected liquid ejecting heads, and each liquid ejecting head transfers the print data toward downstream side device. Since the multiple liquid ejecting heads are connected in series, the number of liquid ejection heads may be changed (i.e., increased or decreased) in accordance with a width of a recording medium.

### SUMMARY

When a relatively large number of liquid ejecting heads are connected in series, a relatively long time period is necessary from a time when the controller transmits the print data until the most downstream liquid ejecting heads receives the print data.

According to aspects of the present disclosure, there is provide a printing apparatus, including a main controlling circuit, a sub-controlling circuit group including first-n-th sub-controlling circuits connected in series, n being integer equal to or more than two, a head group configured to be controlled by the sub-controlling circuit group, the head group is configured to eject liquid, a first communication path configured to connect the main controlling circuit and the first sub-controlling circuit, and a second communication path configured to connect the main controlling circuit and the n-th sub-controlling circuit. When the main controlling circuit transmit first print data to the first sub-controlling circuit via the first communication path, the sub-controlling circuit group transfers the first print data in a forward direction from the first sub-controlling circuit to the n-th controlling circuit. When the main controlling circuit transmit second print data to the n-th sub-controlling circuit via the second communication path, the sub-controlling circuit group transfers the second print data in a reverse direction from the n-th sub-controlling circuit to the first controlling circuit. The sub-controlling circuit group controls driving of the head group based on the first print data and the second print data.

According to aspects of the present disclosure, there is provide a printing method for a printing apparatus having a main controlling circuit, a sub-controlling circuit group including first-n-th sub-controlling circuits connected in series, n being integer equal to or more than two, a head group configured to be controlled by the sub-controlling circuit group, the head group is configured to eject liquid, a first communication path configured to connect the main controlling circuit and the first sub-controlling circuit, and a second communication path configured to connect the main controlling circuit and the n-th sub-controlling circuit. The printing method including, when the main controlling circuit transmit first print data to the first sub-controlling circuit via the first communication path, the sub-controlling circuit group transferring the first print data in a forward direction from the first sub-controlling circuit to the n-th controlling circuit, when the main controlling circuit transmit second print data to the n-th sub-controlling circuit via the second communication path, the sub-controlling circuit group transferring the second print data in a reverse direction from the n-th sub-controlling circuit to the first controlling circuit, and the sub-controlling circuit group controlling driving of the head group based on the first print data and the second print data.

According to aspects of the present disclosure, there is provide a non-transitory computer-readable recording medium for a printing apparatus having a main controlling circuit, a sub-controlling circuit group including first-n-th sub-controlling circuits connected in series, n being integer equal to or more than two, a head group configured to be controlled by the sub-controlling circuit group, the head group is configured to eject liquid, a first communication path configured to connect the main controlling circuit and the first sub-controlling circuit, and a second communication path configured to connect the main controlling circuit and the n-th sub-controlling circuit. The non-transitory computer-readable recording medium containing computer-executable instructions which cause, when executed by a controller of the printing apparatus, the printing apparatus to perform, when the main controlling circuit transmit first print data to the first sub-controlling circuit via the first communication path, causing the sub-controlling circuit group to transfer the first print data in a forward direction from the first sub-controlling circuit to the n-th controlling circuit, when the main controlling circuit transmit second print data to the n-th sub-controlling circuit via the second communication path, causing the sub-controlling circuit group to transfer the second print data in a reverse direction from the n-th sub-controlling circuit to the first controlling circuit, and causing the sub-controlling circuit group to control driving of the head group based on the first print data and the second print data.

### BRIEF DESCRIPTION OF DRAWINGS

FIG. 1 is a transparent plane view schematically showing a structure of a printing apparatus.

FIG. 2 is a transparent plane view of an inkjet head of the printing apparatus.

FIG. 3 is a block diagram of the inkjet head.

FIG. 4 is a block diagram of a k-th head module, where k is a natural number less than or equal to n.

FIG. 5 is a flowchart illustrating a printing process performed by a main controlling circuit according to a first modification.

FIG. 6 is a flowchart illustrating a printing process performed by a main controlling circuit according to a second modification.

FIG. 7 is a plane view schematically showing a positional relationship among heads and sensors according to a fourth modification.

FIG. 8 is a positional relationship among sensors and heads according to a fifth modification.

### DESCRIPTION

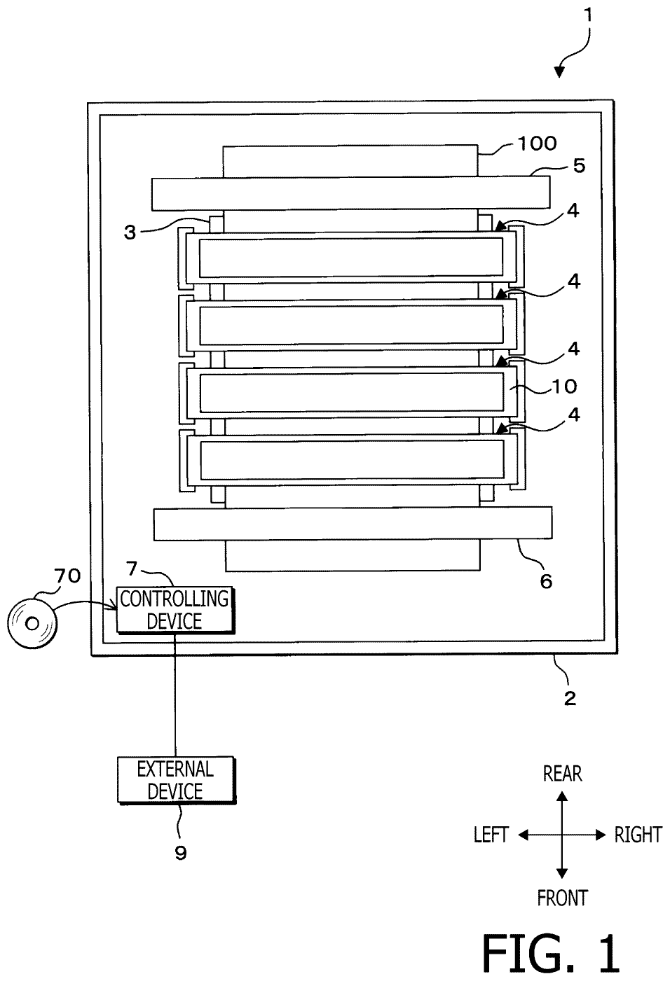

A printing apparatus 1 according to an embodiment will be described with reference to accompanying drawings. FIG. 1 is a transparent plane view of the printing apparatus 1. As shown in FIG. 1, the printing apparatus 1 is configured such that a printing sheet 100 is conveyed in a front-rear direction (see indication of directions shown in FIG. 1) of the printing apparatus 1. The printing sheet 100 is an example of a printing medium. It is noted that a film or a cloth may be employed as the printing medium. Further, a width direction of the printing sheet 100 corresponds to a right-left direction (see indication of directions shown in FIG. 1) of the printing apparatus 1. Further, a direction perpendicular to both the front-rear direction and the right-left direction, that is, a direction perpendicular to the plane of FIG. 1 corresponds to an up-down direction of the printing apparatus 1.

As shown in FIG. 1, the printing apparatus 1 has a platen 3 accommodated in a casing 2, four inkjet heads 4, two conveying rollers 5 and 6, and a controlling device 7. The printing sheet 100 passes above an upper surface of the platen 3. The four inkjet heads 4 are aligned in the sheet conveying direction above the platen 3 and. The each inkjet head 3 is configured as a so-called line-type head. Ink is supplied from ink tanks (not shown) to the inkjet heads 4. It is noted that for different color inks are supplied to the four inkjet heads 4, respectively.

As shown in FIG. 1, the two conveying rollers 5 and 6 are arranged separately, in the front side and rear side, with respect to the platen 3. The two conveying rollers 5 and 6 are driven by a motor (not shown), thereby conveying the printing sheet 100 placed on the platen 3 frontward. The controlling device 7 is communicatively connected with an external device 9 such as a PC, and controls each component of the printing apparatus 1 based on print data transmitted from the external device 9.

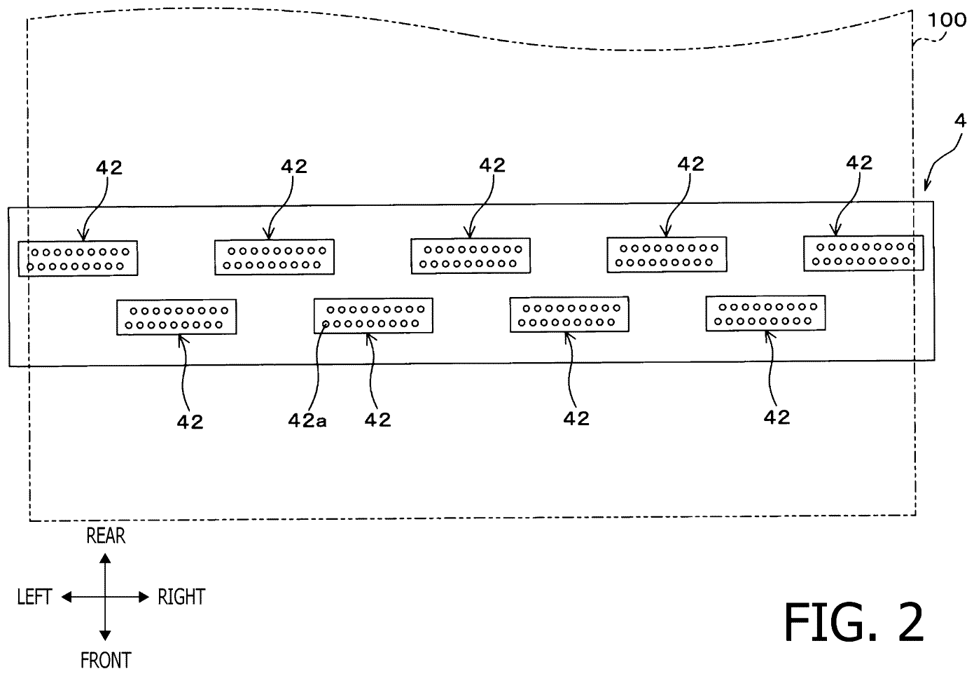

FIG. 2 is a transparent plane view of the inkjet head 4. As shown in FIG. 2, one inkjet head 4 includes multiple heads 42. The multiple heads 42 are arranged in two rows in the front-rear direction. In the front row, in the example shown in FIG. 2, four heads 42 are arranged along the right-left direction, while five heads 42 are arranged in the right-left direction in the rear row. On a lower surface of each head 42, multiple nozzles 42a are formed. The inkjet head 4 has a driving mechanism (not shown) and is configured to be moved to a flushing receptacle (not shown) by the driving mechanism when performing a flushing process.

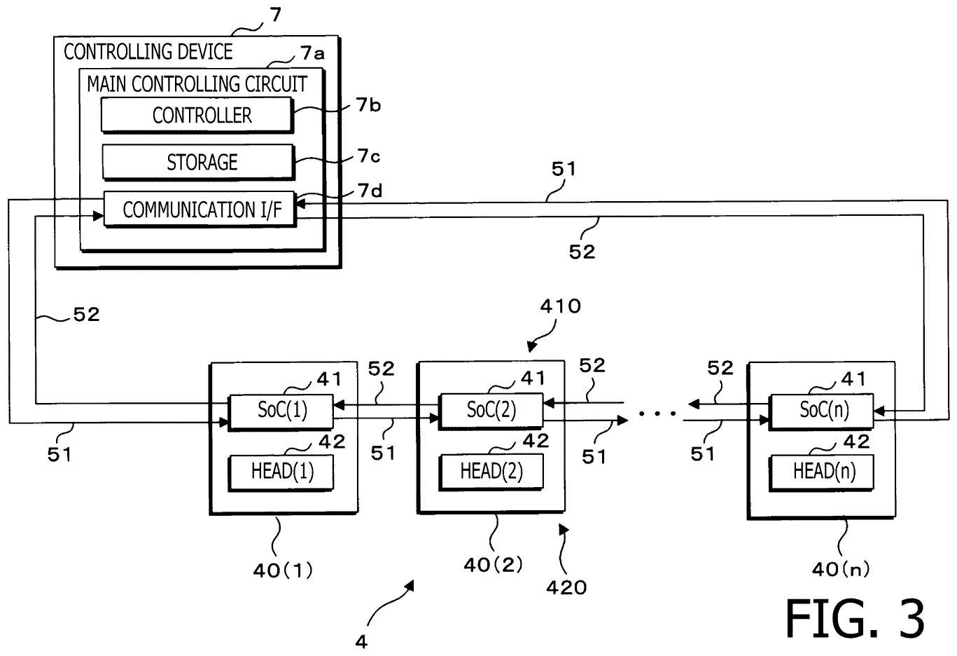

FIG. 3 is a block diagram of the controlling device 7 and the inkjet heads 4. The controlling device 7 has a main controlling circuit 7a. The main controlling circuit 7a includes a controller 7b, a storage 7c and a communication I/F (interface) 7d. The controller 7b has a logic circuit (e.g., an FPGA: Field-Programmable Gate Array). Optionally or alternatively, the controller 7b may have a processor such as a CPU or an ASIC. The storage 7c includes a main storage and an auxiliary storage. An example of the main storage is a RAM. Examples of the auxiliary storage are a ROM, a rewritable storage medium (e.g., an EEPROM, a Flash ROM, a hard disk drive, and the like).

Control programs are stored in the auxiliary storage. The controller 7b retrieves control programs from the auxiliary storage to the main storage, and executes the control programs. The control programs may be installed from a storage medium 70 (see FIG. 1) such as an optical disc or a portable flash memory to the auxiliary storage. The control programs may be downloaded to the auxiliary storage from a server connected to the printing apparatus 1 via a communication network. The communication I/F 7d is connected to a forward communication path 51 and a reverse communication path 52. The controlling device 7 controls the printing apparatus 1 in accordance with the control programs.

The inkjet head 4 includes multiple head modules 40. For example, the multiple head modules 40 are arranged in the right-left direction. The multiple head modules 40 are serially connected via the forward communication path 51, and serially connected via the reverse communication path 52. The multiple head modules 40 include a first head module 40(1), a second head module 40(2), a third head module 40(3), . . . , an n-th head module 40(n), where n is a natural number. The first head module 40(1) is arranged at a leftmost position and the n-th head module 40(n) is arranged at a rightmost position. The first head module 40(1) is arranged at a closest position to the controlling device 7 among all the head modules 40, while the n-th head module 40(n) is arranged at a farthest position from the controlling device 7 among all the head modules 40.

The n-th head module 40(n) is connected to the communication I/F 7d via the forward communication path 51 and the reverse communication path 52. Further, the first head module 40(1) is connected to the communication I/F 7d via the forward communication path 51 and the reverse communication path 52. That is, the first head module 40(1) through the n-th head module 40(n) and the communication I/F 7d are communicably connected in a loop through the forward communication path 51, and also communicably connected in a loop through the reverse communication path 52.

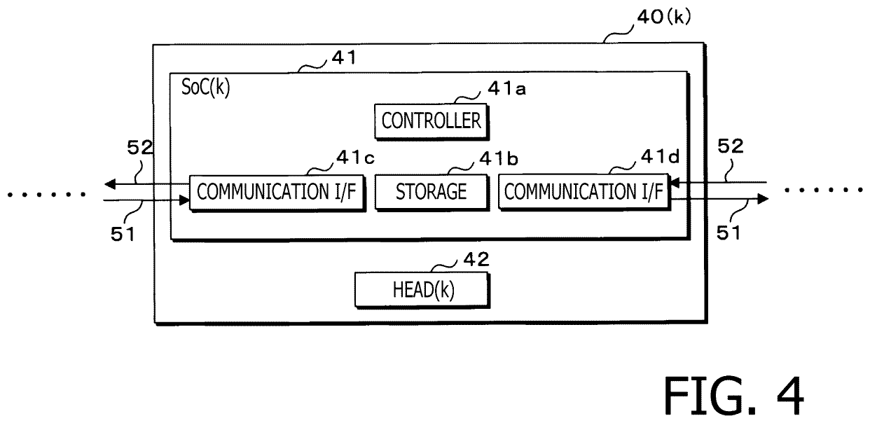

FIG. 4 is a block diagram of a k-th head module 40(k), where k is a natural number smaller than or equal to n. The k-th head module 40(k) includes an SoC (System on Chip) 41, a head 42 and a sensor 43. In the following description, the Soc 41 of the k-th head module 40(k) will also be referred to as an SoC(k), and the head 42 of the k-th head module 40(k) will also be referred to as a head(k). It is noted that the SoC(k) is an example of a sub-controlling circuit. The SoC(k) is provided with a controller 41a, a storage 41b, a communication I/F 41c and a communication I/F 41d. The controller 41a has, for example, a logic circuit or a processor. The storage 41b includes an EEPROM, a Flash ROM, a rewritable storage medium such as a hard disk, a ROM and a RAM. The communication I/F 41c and the communication I/F 41d are connected to the forward communication path 51 and the reverse communication path 52, respectively.

A transferring direction of data in the forward communication path 51 is from SoC(1) to SoC (n), i.e., in a forward direction. Data transmitted from the communication I/F 7d to the SoC(1) via the forward communication path 51 is transferred to the SoC(n).

A transferring direction of data in the reverse communication path 52 is from SoC(n) to SoC(1), i.e., in a reverse direction. Data transmitted from the communication I/F 7d to the SoC(n) via the reverse communication path 52 is transferred to the SoC(1). As shown in FIG. 4, in the forward direction, the communication I/F 41c is located upstream from the communication I/F 41d, and in the reverse direction, the communication I/F 41c is located downstream from the communication I/F 41d.

The multiple SoCs, that is, the SoC(1)-SoC(n) constitute a sub-controlling circuit group 510, and the multiple heads 42, that is, the head(1)-head(n) constitute a head group 420 (see FIG. 3).

Each of the communication I/Fs 7d, 41c, and 41d is an interface capable of communication bidirectionally and is connected in series by the forward communication path 51 and the reverse communication path 52. The forward communication path 51 and the reverse communication path 52 are wiring for transferring print data, status data representing status of each head module 40, and synchronization signals, and the like. For example, the communication I/F 7d transmits print data to the communication I/F 41c of the SoC(1). The communication I/F 41d of the SoC(1) transfers the print data to the communication I/F 41c of the SoC(2), and the communication I/F 41d of the SoC(2) transfers the print data to the communication I/F 41c of the SoC(3). In this way, the print data is transferred in sequence to the communication I/F 41c of the SoC(n).

For example, the communication I/F 7d transmits print data to the communication I/F 41d of the SoC(n). The communication I/F 41c of the SoC(n) transfers the print data to the communication I/F 41d of the SoC(n−1), and the communication I/F 41c of the SoC(n−1) transfers the print data to the communication I/F 41d of the SoC (n−2). In this way, the print data is transferred in sequence up to the communication I/F 41d of the SoC(1).

The print data includes identifiers of the SoC(1)-SoC(n) and image information associated with each identifier. For example, in the forward direction, each of the controllers 41a of the SoC(1)-SoC(n) obtains the image information associated with their own identifiers from the received print data. That is, each controller 41a stores the image information associated with its own identifier (i.e., an identifier of the each controller 41a) in the storage 41b. For example, the controller 41a stores the print data in a first area of the storage 41b and copies the image information associated with its own identifier from the print data stored in the first area to a second area of the storage 41b.

Each of the controllers 41a of the SoC(1)-SoC(n−1) deletes image information associated with its own identifier from the received print data, and transfers the print data to the downstream SoC in the forward direction. For example, the controller 41a deletes the image information stored in the second area from the print data stored in the first area, and then transfers the print data stored in the first area to the downstream SoC. It should be noted that the controller 41a may transfer the print data to the downstream SoC without deleting the image information associated with its own identifier.

For example, in the reverse direction, the controllers 41a of the SoC(n)-SoC(1) obtain the image information associated with their own identifiers from the received print data. That is, each controller 41a stores the image information associated with its own identifier in the storage 41b. For example, the controller 41a stores the print data in the first area of the storage 41b and copies the image information associated with its own identifier from the print data stored in the first area to the second area of the storage 41b.

The controllers 41a of the SoC(n)-SoC(2) delete the image information associated with their own identifiers from the received print data and transfer the print data to the downstream SoC in the reverse direction. For example, the controller 41a deletes the image information stored in the second area from the print data stored in the first area, and then transfers the print data stored in the first area to the downstream SoC. It should be noted that the controller 41a may transfer the print data to the downstream SoC without deleting the image information associated with its own identifier. Each of the SoC(1)-SoC(n) is configured to transmit data indicating receipt confirmation of the print data to the main controlling circuit 7a via the forward communication path 51 or the reverse communication path 52.

The conveying rollers 5 and 6 are connected to a motor (not shown), and the motor is provided with an encoder (not shown) which detects a rotational position and speed of the motor. The rotational position and the speed of the motor corresponds to a location of the printing sheet 100 in the front-rear direction, and the encoder is configured to transmit a synchronization signal to the main controlling circuit 7a every time when the encoder detects a rotational position corresponding to a printing position (i.e., a position at which one line of printing is performed on the printing sheet 100). The one line is a particular printing area extending in the right-left direction on the printing sheet 100. The main controlling circuit 7a transmits the synchronization signal to the SoC(1)-SoC(n) as necessary. The SoC(1)-SoC(n) drive the head(1)-head(n) at the time indicated by the synchronization signal to eject ink droplets from the nozzles 42a.

The print data transmitted from the external device 9 to the controlling device 7 includes first print data and second print data. A piece of print data is data for printing one line. For example, the first print data includes identifiers of the SoC(1)-SoC(k), and image information associated with respective identifiers, and the second print data includes identifiers of the SoC(k+1)-SoC(n), and image information associated with respective identifiers. K is approximately half of n. For example, when n is even, k is n/2, while when n is odd, k is (n−1)/2 or (n+1)/2.

The main controlling circuit 7a transmits the first print data to the SoC(1) via the forward communication path 51. The first print data is transferred from the SoC(1) to the SoC(k). The SoC(1)-SoC(k) obtain image information associated with their own identifiers, and drive the head(1)-head(k) based on the image information. The SoC(k) transmits a signal indicating the completion of transmitting the first print data to the main controlling circuit 7a via the forward communication path 51 or the reverse communication path 52.

The main controlling circuit 7a transmits the second print data to the SoC(n) via the reverse communication path 52. The second print data is transferred from the SoC(n) to the SoC(k+1). The SoC(n)-SoC(k+1) obtain image information associated with their own identifiers, and drive the head(n)-head(k+1) based on the image information. The SoC(k+1) transmits a signal indicating the completion of transmitting the second print data to the main controlling circuit 7a via the forward communication path 51 or the reverse communication path 52.

Since the first print data is transferred from the SoC(1) in the forward direction and the second print data is transferred from the SoC(n) in the reverse direction, compared to a case where the print data is transmitted only in the forward or reverse direction, the time from when the controlling device 7 starts transmitting the first and second print data to when the first or second print data reaches all of the SoC(1)-SoC(n) can be shortened.

The first print data may include half of the data for one line of data, and the second print data may include remaining half of the data for one line of data. In such a case, the first print data may be transferred, for example, from the SoC(1) to an SoC(p) via the forward communication path 51, where p is a natural number greater than or equal to 2. The SoC(1)-SoC(s) obtain the image information associated with their own identifiers and drive the head(1) to head(p) based on the image information. The SoC(p) transmits a signal, which indicates the completion of transmitting the first print data, to the main controlling circuit 7a via the forward communication path 51 or the reverse communication path 52. The second print data is transferred from the SoC(n) to the SoC(p+1) via the reverse communication path 52. The SoC(n)-SoC(p+1) obtain the image information associated with their own identifiers and drive the head(n)-head(p+1) based on the image information. The SoC (p+1) transmits a signal, which indicates the completion of transferring the second print data, to the main controlling circuit 7a via the forward communication path 51 or the reverse communication path 52.

The difference between the time taken for the first print data to reach all of the SoC(1)-SoC(p) after the controlling device 7 starts transferring the first print data and the time taken for the second print data to reach all the SoC(n)-SoC(p+1) after the controlling device 7 starts transferring the second print data is almost eliminated. Therefore, the waiting time generated in the SoC(1)-SoC(p) after the first print data is obtained, or the waiting time generated in the SoC(n)-SoC(p+1) after the second print data is obtained, is minimized. It should be noted that when the first and second print data are compressed data, the amount of both compressed data is equal. Even when transmitting or transferring the compressed data, the waiting time generated in the SoC(1)-SoC(p) after the first print data is obtained, or the waiting time generated in the SoC(n)-SoC(p+1) after the second print data is obtained, is minimized.

It should be noted that data to drive the head(1)-head(q) may be assigned to the first print data and data to drive the head(n)-head(q+1) may be assigned to the second print data in such a manner that the difference in data amount between the first and second print data is minimized, where q is a natural number of 2 or more. For example, the print area may be biased toward the leftmost part of one line and the data to drive the head(1)-head(q) corresponding to the leftmost part is assigned to the first print data, while the data to drive the head(n)-head(q+1) corresponding to the part of one line other than the leftmost part may be assigned to the second print data. In such a case, the waiting time generated in the SoC(1)-SoC(q) after obtaining the first print data, or the waiting time generated in the SoC(n)-SoC(q+1) after obtaining the second print data, can be reduced.

When the printing sheet 100 has a first area and a second area wider than the first area, print data to print on the first area and print data to print on a part of the second area are assigned to the first print area, while print data to print the remaining part of the second area is assigned to the second print data in such a manner that the amount of the first and second print data are substantially equal. For example, when the head(1)-head(r) correspond to the first area and a part of the second area, and the head(n)-head(r+1) correspond to the rest of the second area (r being a natural number of 2 or more), the waiting time generated in the SoC(1)-SoC(r) after the first print data is obtained or the waiting time generated in the SoC(n)-SoC(r+1) after the second print data is obtained is the smallest. In another example, when a company logo is printed in the first area and text is printed in the second area, the first print data includes the company logo and a part of the text string, while the second data includes the remaining text string not included in the first data.

It should be noted that the first and second print data may include different color data. When black, yellow, magenta, and cyan inks are supplied to the inkjet head 4, each head 42 has nozzles 42a ejecting black ink, nozzles 42a ejecting yellow ink, nozzles 42a ejecting magenta ink, and nozzles 42a ejecting cyan ink. In such a case, the first print data includes black print data and the second print data includes yellow, magenta and cyan data. When performing color printing on white printing sheet 100, black ink is most frequently used compared to yellow, magenta, and cyan inks. For example, in one line of print data, the difference between the amount of black print data and the total amount of yellow, magenta and cyan print data is small. That is, the difference between the amount of the first print data and the amount of the second print data is small.

The main controlling circuit 7a transmits the first print data, i.e., print data for the black color, to the SoC(1) via the forward communication path 51. The first print data is transferred from the SoC(1) to the SoC(n). The SoC(1)-SoC(n) obtain the image information associated with their own identifiers from the first print data, respectively. The SoC(n) transmits a signal, which indicates the completion of transferring the first print data, to the main controlling circuit 7a via the forward communication path 51 or the reverse communication path 52. The main controlling circuit 7a transmits the second print data, i.e., print data for the yellow, magenta and cyan inks, to the SoC(n) via the reverse communication path 52. The second print data is transferred from the SoC(n) to the SoC (1). The SoC(n)-SoC(1) obtain the image information associated with their own identifiers from the second print data. The SoC(1) transmits a signal, which indicates the completion of transferring the second print data, to the main controlling circuit 7a via the forward communication path 51 or the reverse communication path 52.

The difference between the time from when the controlling device 7 starts transmitting the first printing data until the first printing data reaches all of the SoC(1)-SoC (n) and the time from when the controlling device 7 starts transmitting the second printing data until the second printing data reaches all of the SoC(n) to SoC(1) is small. That is, the waiting time generated in the SoC(1)-SoC(n) after obtaining the first or second print data is small.

When the white, black, yellow, magenta, and cyan inks are supplied to inkjet head 4, for example, each head 42 is equipped with nozzles 42a configured to eject white, black, yellow, magenta, and cyan inks. The first print data includes white print data and the second print data includes black, yellow, magenta and cyan data. In color printing, where the white ink is ejected onto the printing sheet 100 as the base color, the white ink is used most frequently compared to the black, yellow, magenta, and cyan inks. That is, the difference between the amount of the first print data and the amount of the second print data is small.

The main controlling circuit 7a transmits the first print data, i.e., the white print data, to the SoC(1) via the forward communication path 51. The first print data is transmitted from the SoC(1) to the SoC(n). The SoC(1)-SoC(n) obtain image information associated with their own identifiers from the first print data. The SoC(n) transmits a signal indicating the completion of transmitting the first print data to the main controlling circuit 7a via the forward communication path 51 or the reverse communication path 52. The main controlling circuit 7a transmits the second print data, i.e., the black, yellow, magenta, and cyan print data, to the SoC(n) via the reverse communication path 52. The SoC(n)-SoC(1) obtains the image information associated with their own identifiers from the second print data. The SoC(1) transmits a signal indicating the completion of transferring the second print data to the main controlling circuit 7a via the forward communication path (51) or reverse communication path (52). The difference between the time from when the controlling device 7 starts transmitting the first printing data until the first printing data reaches all of the SoC(1) to SoC(n) and the time from when the controlling device 7 starts transmitting the second printing data until the second printing data reaches all of the SoC(n) to SoC(1) is small. That is, the waiting time generated in the SoC(1)-SoC(n) after obtaining the first or second print data is small.

It should be noted that the first print data may include data for the first and second colors, and the second print data may include data for the third and fourth colors. In such a case, for example, data for the first and second colors are assigned to the first print data, and data for the third and fourth colors are assigned to the second print data in such a manner that the difference between the amounts of the first and second print data is minimized. For example, when the black, yellow, magenta, and cyan inks are supplied to the inkjet head 4, each head 42 is equipped with nozzles 42a configured to eject the black, yellow, magenta, and cyan inks. The first print data includes print data for two out of four colors of the black, yellow, magenta and cyan, while the second print data includes data for the remaining two out of the four colors of the black, yellow, magenta and cyan.

The main controlling circuit 7a transmits the first print data, i.e., the first and second color print data, to the SoC(1) via the forward communication path 51. The first print data is transferred from the SoC(1) to the SoC(n). The SoC(1)-SoC(n) obtain the image information associated with their own identifiers from the first print data. The SoC(n) transmits a signal indicating the completion of transferring the first print data to the main controlling circuit 7a via the forward communication path 51 or the reverse communication path 52. The main controlling circuit 7a transmits the second print data, i.e., the print data for the third and fourth colors, to the SoC(n) via the reverse communication path 52. The second print data is transferred from the SoC(n) to the SoC(1). The SoC(n)-SoC(1) obtain the image information associated with their own identifiers from the second print data. The SoC(1) transmits a signal indicating the completion of transferring the second print data to the main controlling circuit 7a via the forward communication path (51) or the reverse communication path (52). The difference between the time from when the controlling device 7 starts transmitting the first printing data until the first printing data reaches all of the SoC(1)-SoC(n) and the time from when the controlling device 7 starts transmitting the second printing data until the second printing data reaches all of the SoC(n)-SoC(1) is small. That is, the waiting time generated in the SoC(1)-SoC(n) after obtaining the first or second print data is small.

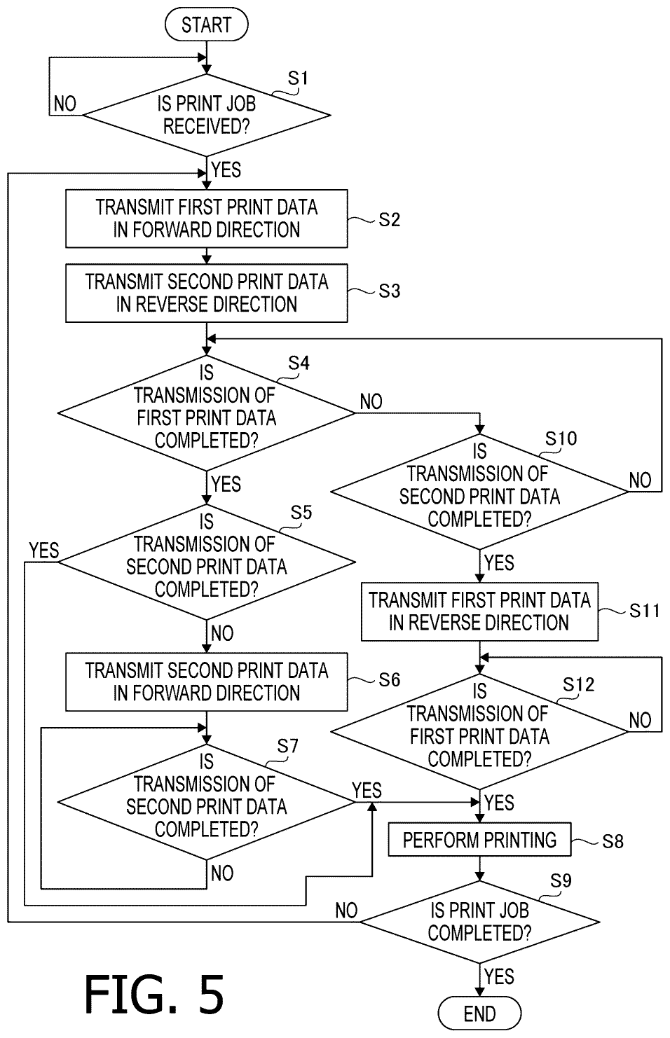

Hereinafter, a printing apparatus 1 according to a first modification will be described with reference to FIG. 5. Among configurations of the printing apparatus 1 for a first modification, components similar to those in the above-described embodiment are assigned the same references, and their detailed descriptions will be omitted.

FIG. 5 is a flowchart illustrating a printing process by the main controlling circuit 7a according to the first modification. The controller 7b of the main controlling circuit 7a determines whether a print job has been received from the external device 9 (S1). The print job is, for example, a job to print one page. When it is determined that no print job has been received (S1: NO), the controller 7b returns the process to S1. When it is determined that a print job has been received (S1: YES), the controller 7b transmits the first print data to the SoC(1) via the forward communication path (51) in S2, and the second print data to the SoC(n) via the reverse communication path (52) in S3. The first and second print data, for example, are print data for printing one line.

The controller 7b determines whether a signal indicating the completion of transferring the first print data has been received (S4). When it is determined that a signal indicating the completion of transferring the first print data has not been received (S4: NO), the controller 7b determines whether a signal indicating the completion of transferring the second print data has been received (S10). When it is determined that a signal indicating the completion of transferring the second print data has not been received (S10: NO), the controller 7b returns the process to S4.

When it is determined that a signal indicating the completion of transferring the first print data has been received (S4: YES), the controller 7b determines whether a signal indicating the completion of transferring the second print data has been received (S5). When it is determined that a signal indicating the completion of transferring the second print data has not been received (S5: NO), the controller 7b transmits the second print data to the SoC(1) via the forward communication path (51) in S6.

That is, after transferring of the first print data in the forward direction has been completed, when transmission of the second print data in the reverse direction has not been completed, the second print data is retransmitted via the forward communication path 51. Accordingly, the SoCs that have not received the second print data can receive the second print data via the forward communication path 51.

The controller 7b determines whether a signal indicating the completion of transferring the second print data has been received (S7). It is noted that when the SoCs receive the second print data via both the forward communication path 51 and the reverse communication path 52, they transmit a signal indicating that the completion of transferring of the second print data to the main controlling circuit 7a. When it is determined that a signal indicating the completion of transmitting the second print data has not been received (S7: NO), the controller 7b returns the process to S7.

When it is determined that a signal indicating the completion of transferring the second print data has been received (S10: YES), the controller 7b transmits the first print data to the SoC(n) via the reverse communication path (52) in S11.

That is, when the transferring of the first print data in the forward direction has not been completed after the transferring of the second print data in the reverse direction has been completed, the first print data is retransmitted via the reverse communication path 52. The SoCs that have not received the first print data can receive the first print data via the reverse communication path 52.

The controller 7b determines whether a signal indicating the completion of transferring the first print data has been received (S12). When the SoCs receive the first print data via both the forward communication path (51) and the reverse communication path (52), each of the SoCs transmits a signal to the main controlling circuit 7a indicating the completion of transferring the first print data. When it is determined that a signal indicating the completion of transferring the first print data has not been received (S12: NO), the controller 7b returns the process to S12.

When it is determined that a signal indicating the completion of transferring the second print data has been received in steps S5 and S7 (S5: YES, S7: YES), or when it is determined that a signal indicating the completion of transferring the first print data has been received in step S12 (S12: YES), i.e., when it is determined that a signal indicating the completion of transferring the first and second print data, the controller 7b drives the head(1) to head(n), and ejects ink from the nozzles 42a, thereby executing printing (S8). The controller 7b determines whether the print job is completed or not (S9).

When it is determined that the print job is not complete (S9: NO), the controller 7b returns the process to S2. When it is determined that the print job is completed (S9: YES), the controller 7b terminates the process.

In the printing apparatus 1 according to the first modification, when transferring of the second print data in the reverse direction has not been completed after transferring of the first print data in the forward direction has been completed, the SoCs that have not received the second print data can receive the second print data via the forward communication path 51. Further, when transferring of the first print data in the forward direction has not been completed after transferring of the second print data in the reverse direction has been completed, the SoCs that have not received the first print data can receive the first print data via the reverse communication path 52. Therefore, the time from when the main controlling circuit 7a starts transmitting the first and second print data until all the SoCs obtain the first or second print data can be shortened.

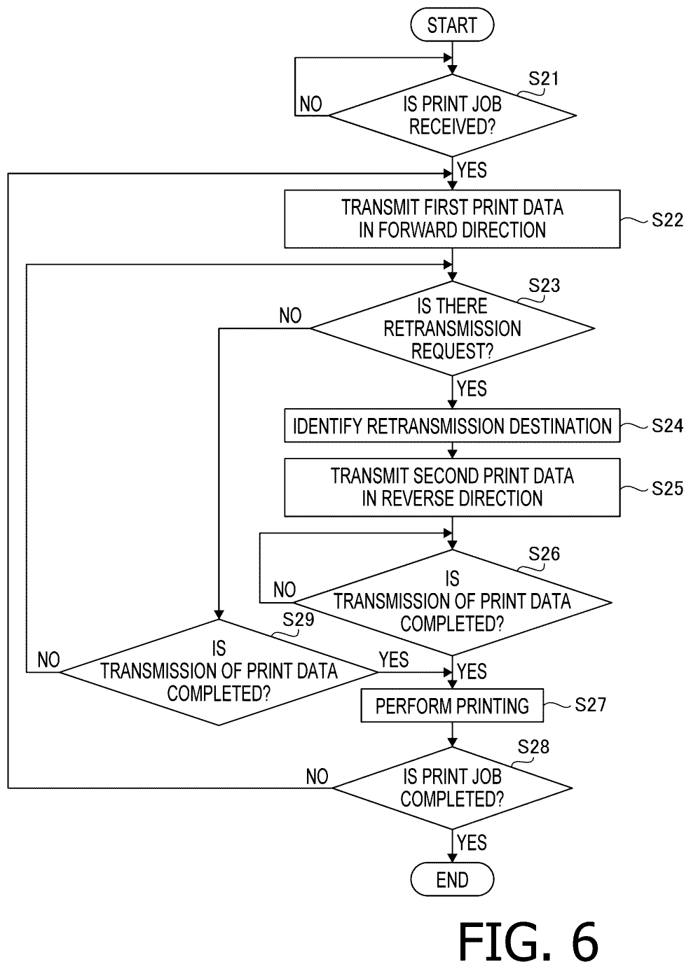

Hereinafter, a printing apparatus 1 according to a second modification will be described with reference to FIG. 6. Among configurations of the printing apparatus 1 for the second modification, components similar to those in the above-described embodiment and/or the first modification are assigned the same references, and their detailed descriptions will be omitted.

FIG. 6 is a flowchart illustrating a print process performed by the controlling circuit 7a according to the second modification. The controller 7b of the main controlling circuit 7a determines whether a print job is received from the external device 9 (S21). The print job is, for example, a job for printing one page. When it is determined that print job has not been received (S21: NO), the controller 7b returns the process to S21. When it is determined that a print job has been received (S21: YES), the controller 7b transmits the first print data to the SoC (1) via the forward communication path (51) in S22.

The controller 7b determines whether a retransmission request has been received from one of the SoCs (S23). When the communication between SoC(k) and the SoC(k+1) via the forward communication path 51 fails and the SoC(k+1) has not obtained the image information associated with its own identifier, for example, the SoC(k+1) requests the controller 7b to retransmit the image information via the reverse communication path 52. The retransmission request includes an identifier indicating the SoC to which the retransmission is to be transmitted.

When it is determined that a retransmission request has been received from one of the SoCs (S23: YES), the controller 7b identifies a retransmission destination based on the identifier included in the retransmission request (S24) and transmits the second print data to the SoC(n) via the reverse communication path 52 (S25). The second print data includes an identifier indicating the SoC of the resend destination and image information associated with the identifier indicating the SoC of the resend destination. That is, the second print data includes the same data as the first print data. The sub-controlling circuit group 410 transfers the second print data in the reverse direction until the SoC to which the data is to be retransmitted receives the second print data.

The controller 7b determines whether transferring of the print data has completed (S26). When the controller 7b receives, from the SoC(1)-SoC(n), signals indicating that image information associated with their own identifiers have been obtained, the controller 7b determines that the transferring of the print data has been completed. When it is determined that transferring of the print data has not been completed (S26: NO), the controller 7b returns the process to S26. When it is determined that the transferring of the print data is completed (S26: YES), the controller 7b drives the head(1)-head(n) to eject ink from the nozzles 42a to perform printing (S27). The controller 7b determines whether the print job is completed (S28).

When it is determined that the print job is not completed (S28: NO), the controller 7b returns the process to S22. When it is determined that the print job is completed (S28: YES), the controller 7b terminates the process.

When it is determined in S23 that there is no retransmission request from any of the SoCs (S23: NO), the controller 7b determines whether the transferring of the print data is completed or not (S29). When it is determined that the transferring of the print data has not been completed (S29: NO), the controller 7b returns the process to S23. When it is determined that transferring of the print data is completed (S29: YES), the controller 7b proceeds to S27.

In the second modification, the first print data is transferred in the forward direction, it is determined whether the retransmission request is received from one of the SoCs. When it is determined that the retransmission request is received from one of the SoCs, the second print data is transmitted in the reverse direction. Therefore, even when data transferring in the forward direction fails, data is retransmitted in the reverse direction and all the SoCs can obtain the print data. It should be noted that the first print data may be transmitted in the reverse direction, it may be determined whether the retransmission request is received. When the retransmission request is received, the second print data may be transmitted in the forward direction. Concretely, in S22, the controller 7b transmits the first print data to the SoC(n) via the reverse communication path 52. In S23, the controller 7b determines whether a retransmission request has been received from any of the SoCs. When it is determined that a retransmission request has been received from any of the SoCs (S23: YES), the controller 7b identifies a retransmission destination in S24 based on an identifier included in the retransmission request. Then, in S25, the controller 7b transmits the second print data to the SoC(1) via the forward communication path 51. The sub-controlling circuit group 410 transfers the second print data in the forward direction until the SoC of the retransmission destination (i.e., the SoC that transmits the retransmission request) receives the second print data.

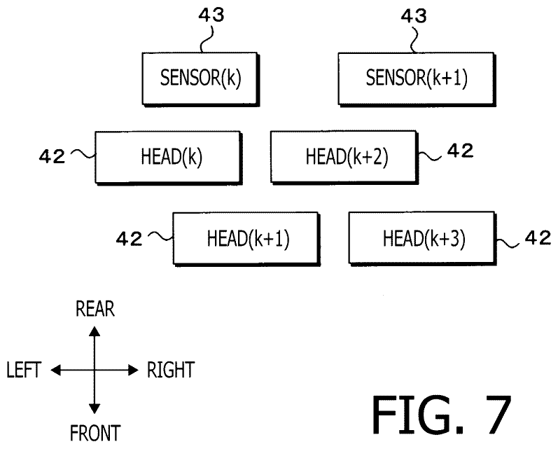

Hereinafter, a printing apparatus 1 according to a third modification will be described referring to FIG. 7. Among the configurations of the printing apparatus 1 according to the third modification, components the same as those in the embodiment and the third modification are assigned with the same symbols, and detailed descriptions thereof will be omitted.

FIG. 7 is a plane view that schematically shows a positional relationship between heads and sensors. As an example, a head(k)-head(k+3) will be described. The head(k) and the head(k+2) are aligned in the right-left direction. The head(k+2) is located on the right side of the head(k). The head(k+1) is located between the head(k) and the head(k+2) in the right-left direction, and in front of the head(k) and the head(k+2) in the front-rear direction. A right part of the head(k) and a left part of the head(k+1) overlap in the front-rear direction. The head(k+3) is located on the right side of the head(k+2) in the right-left direction and in front of the head(k+2) in the front-rear direction. A right part of the head(k+2) and a left part of the head(k+3) overlap in the front-rear direction. The head(k+1) and the head(k+3) are aligned in the right-left direction.

The printing apparatus 1 is equipped with multiple sensors 43. The number of the multiple sensors 43 is even. Each of the sensors 43 is an image sensor configured to scan an image printed on the printing sheet 100. The sensor 43 is an example of a scanner. The multiple sensors 43 include a sensor(k) and a sensor(k+1). The sensor(k) is located on a rear side of a right part of the head(k). That is, the right part of the head(k), the left part of the head(k+1), and the sensor(k) overlap in the front-rear direction. That is, the right part of the head(k+2), the left part of the head(k+3), and the sensor(k+1) overlap in the front-rear direction. The sensor(k) and the sensor(k+1) are aligned in the right-left direction, along the SoC(1)-SoC(n) (i.e., the sub-controlling circuit group).

Since the printing sheet 100 moves from front to rear, the sensor(k) can scan the image, which is formed on the printing sheet 100 by driving the head(k), and the image formed on the printing sheet 100 by driving the head(k+1). Further, the sensor(k+1) can scan the image formed on the printing sheet 100 by driving the head(k+2) and the image formed on the printing sheet 100 by driving the head(k+3).

When it is assumed that the image formed by driving the head(k) is a first image and the image formed by driving the head(k+1) is a second image, the SoC(k) and the SoC(k+1) adjust drive timings of the head(k) and the head(k+1) in such a manner that the first image and the second image are formed at different positions. The sensor(k) scans the first and second images and transmits the data indicating the first image and the data indicating the second image to the SoC(k), which stores the same in the storage 41b.

The controller 41a of the SoC(k) transfers the data indicating the first image stored in the storage 41b and the data indicating the second image to the main controlling circuit 7a via, for example, the reverse communication path 52. That is, the data indicating the first image and the data indicating the second image are transmitted by the SoC(1)-SoC(k) to the main controlling circuit 7a in the opposite directions, respectively. The controller 7b of the main controlling circuit 7a can determine a driving state of the head(k), the presence or absence of an abnormality, and the like, based on data indicating the first image. Further, the controller 7b of the main controlling circuit 7a can determine a driving state of the head(k+1), the presence or absence of an abnormality, and the like, based on data indicating the second image.

When it is assumed that an image formed by driving the head(k+2) is a third image and an image formed by driving the head(k+3) is a fourth image, the SoC(k+2) and the SoC(k+3) adjust drive timings of the head(k+2) and head(k+3) so that the third image and fourth image are formed at different positions. The sensor(k+1) scans the third and fourth images and stores the data indicating the third image and the data indicating the fourth image in the storage 41b of the SoC(k+2).

The controller 41a of the SoC(k+2) transmits the data indicating the third image and the data indicating the fourth image stored in the storage 41b to the main controlling circuit 7a via, for example, the forward communication path 51. That is, the data indicating the third image and the data indicating the fourth image are transmitted by the SoC(k+2)-SoC(n), in the forward direction, to the main controlling circuit 7a. The controller 7b of the main controlling circuit 7a can determine a driving state of the head(k+2), the presence or absence of an abnormality, and the like, based on the data indicating the third image. Further, the controller 7b of the main controlling circuit 7a can determine a driving state of the head(k+3), the presence or absence of an abnormality, and the like, based on the data indicating the fourth image.

It is noted that the sensor(k) may transmit the first and second image data to the SoC(k+1), the controller 41a of the SoC(k+1) may store the first and second image data in the storage 41b, and the controller 41a of the SoC(k+1) may transfer the first and second image data in the reverse direction. It should be noted that the sensor(k) may transmit the first image data to the SoC(k), and the controller 41a of the SoC(k) may store the data in the storage 41b. Further, the sensor(k) may transmit the second image data to the SoC(k+1), the controller 41a of the SoC(k+1) may store the second image data in the storage 41b, and the controller 41a of the SoC(k) may transfer the first image data in the reverse direction, and the controller 41a of the SoC(k+1) may transfer the second image data in the reverse direction.

The sensor(k+1) may store the third and fourth image data in the storage 41b of the SoC(k+3), and the controller 41a of the SoC(k+3) may transfer the third and fourth image data in the forward direction. Further, the sensor(k+1) may store the third image data in the storage 41b of the SoC(k+2) and the fourth image data in the storage 41b of the SoC(k+3), the controller 41a of the SoC(k+2) may transfer the third image data in the forward direction, the controller 41a of the SoC(k+3) may transfer the fourth image data in the forward direction.

The first and second image data scanned by the sensor(k) may be transferred in the forward direction, and the third and fourth image data scanned by the sensor(k+1) may be transferred in the reverse direction.

In the printing apparatus 1 according to the third modification, the data indicating the image scanned by each sensor is transferred, by the SoC(1)-SoC(n), separately in the forward and reverse directions. The number of the sensors 43 is even, and data indicating an image scanned by one of the adjacent sensors 43 is transferred in the forward direction, while data indicating an image scanned by the other of the adjacent sensors 43 is transferred in the reverse direction. Since data indicating an image scanned by the sensors 43 are transferred separately in the forward and reverse directions, a time required to complete the transfer can be reduced in comparison to a case where data is transferred only in the forward direction or only in the reverse direction.

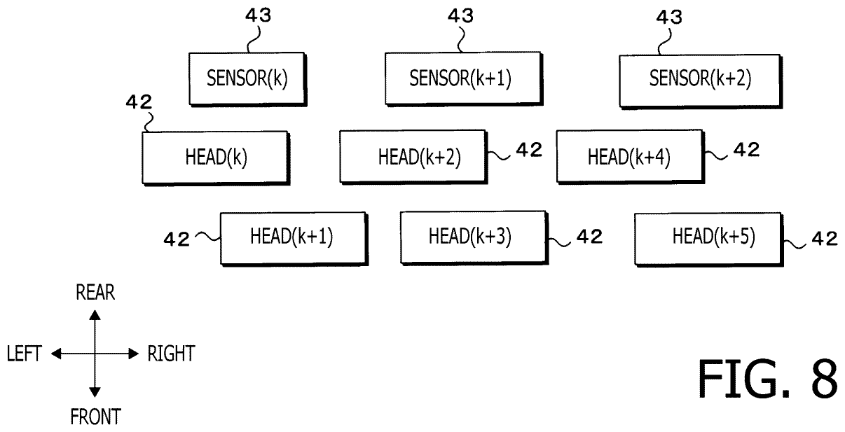

Hereinafter, a printing device 1 according to a fourth modification will be described referring to FIG. 8. Among the configurations of the printing device 1 according to the third modification, components the same as those in the embodiment and the second and third modifications are assigned with the same symbols, and detailed descriptions thereof will be omitted.

FIG. 8 is a plane view that schematically shows a positional relationship between heads and sensors. As an example, a head(k)-head(k+5) will be described. The head(k) and the head(k+2) are aligned in the right-left direction. The number of the SoC(k)-SoC(k+5) that control the driving of the head(k)-head(k+5) is even. The printing apparatus 1 is equipped with multiple sensors 43. The number of the multiple sensors is odd. The sensor 43 is an image sensor configured to scan an image printed on the printing sheet 100. The multiple sensors 43 include the sensor(k)-sensor(k+2). The sensor(k)-sensor(k+2) are aligned in the right-left direction and are aligned along the SoC(1)-SoC(n) (i.e., the sub-controlling circuit group). The positional relationship among the head(k)-head(k+3), the sensor(k) and the sensor(k+1) is the same as in the third modification.

The head(k), the head(k+2) and the head(k+4) are aligned in the right-left direction. The head(k+4) is located on the right side of the head(k+2). The head(k+3) is located between the head(k+2) and the head(k+4) in the right-left direction, and on the front side with respect to the head(k+2) and the head(k+4) in the front-rear direction. The head(k+5) is located on the right side of the head(k+3) in the right-left direction and on the front side of the head(k+4) in the front-rear direction. The right part of head (k+4) and the left part of head (k+5) overlap in the front-rear direction. The head(k+1), the head(k+3) and the head(k+5) are aligned in the right-left direction. The sensor(k+2) is located on the rear side of the right part of the head(k+4). That is, the right part of the head(k+4), the left part of the head(k+5), and the sensor(k+2) overlap in the front-rear direction.

Since the printing sheet 100 moves from the front to the rear, the sensor(k+2) can scan the image formed on the printing sheet 100 by driving the head(k+4) and the image formed on the printing sheet 100 by driving the head(k+5).

The sensor(k) scans the first and second images, transmits the data indicating the first image to the SoC(k) and stores the data in the storage 41b of the SoC(k). Further, the sensor(k) transmits the data indicating the second image to the SoC(k+1) and stores the data in the storage 41b of the SoC(k+1). The sensor(k+1) scans the third and fourth images, transmits the data indicating the third image to the SoC(k+2) and stores the data in the storage 41b of the SoC(k+2). Further, the sensor (k+1) transmits the data indicating the fourth image to the SoC(k+3) and stores the data in the storage 41b of the SoC(k+3).

When it is assumed that an image formed by driving the head(k+4) is a fifth image and an image formed by driving the head(k+5) is a sixth image, the SoC(k+4) and the SoC(k+5) will adjust driving timings of the head(k+4) and head(k+5) in such a manner that the fifth and sixth images are formed in different positions. The sensor(k+2) scans fifth and sixth images, transmits the data indicating the fifth image to SoC (k+4), and stores the data in the storage 41b of the SoC(k+4). Further, the sensor(k+2) transmits the data indicating a sixth image to the SoC(k+5), and stores the data in the storage 41b of the SoC(k+5).

For example, the controller 41a of the SoC(k) transmits the data indicating the first image to the main controlling circuit 7a via the reverse communication path 52. The controller 41a of the SoC(k+2) transfers the data indicating the third image to the main controlling circuit 7a via the reverse communication path 52. The controller 41a of the SoC(k+2) transmits the data indicating the fifth image to the main controlling circuit 7a via the reverse communication path 52.

The controller 41a of the SoC(k+1) transmits the data indicating the second image to the main controlling circuit 7a via the forward communication path 51. The controller 41a of the SoC(k+3) transmits the data indicating the fourth image to the main controlling circuit 7a via the forward communication path 51. The controller 41a of the SoC(k+5) transmits the data indicating the sixth image to the main controlling circuit 7a via the forward communication path 51.

That is, the SoC(k) transfers the data indicating the first image in the reverse direction, and the SoC(k+1) transfers the data indicating the second image in the forward direction. The SoC(k) corresponds to one of adjacent sub-controlling circuits, and the SoC(k+1) corresponds to the other of the adjacent sub-controlling circuits. The SoC(k+2) transfers the data indicating the third image in the reverse direction, and the SoC(k+3) transfers the data indicating the fourth image in the forward direction. The SoC(k+2) corresponds to one of adjacent sub-controlling circuits, and the SoC(k+3) corresponds to the other of adjacent sub-controlling circuits. The SoC(k+4) transfers the data indicating the fifth image in the reverse direction, and the SoC(k+4) transfers the data indicating the sixth image in the forward direction. The SoC(k+4) corresponds to one of adjacent sub-controlling circuits, and the SoC(k+5) corresponds to the other of adjacent sub-controlling circuits. Since data indicating images scanned by each of the sensors 43 is transferred separately in the forward and reverse directions, the time required to complete transfer can be reduced compared to a case where data is transferred only in the forward direction or only in the reverse direction.

It should be noted that in the third and fourth modifications, one sensor 43 scans the image formed by two heads, but the printing apparatus 1 may have the number of sensors 43 the same as the number of the heads, and one sensor 43 may scan the image formed by one head.

It should be noted that the computer program can be deployed to run on a single computer, or on multiple computers arranged at a single site or distributed across multiple sites and interconnected by a communication network.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiment and modifications of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing apparatus, comprising:
a main controlling circuit;
a sub-controlling circuit group including first-n-th sub-controlling circuits connected in series, n being integer equal to or more than two;
a head group configured to be controlled by the sub-controlling circuit group, the head group is configured to eject liquid;
a first communication path configured to connect the main controlling circuit and the first sub-controlling circuit; and
a second communication path configured to connect the main controlling circuit and the n-th sub-controlling circuit,
wherein, when the main controlling circuit transmit first print data to the first sub-controlling circuit via the first communication path, the sub-controlling circuit group transfers the first print data in a forward direction from the first sub-controlling circuit to the n-th controlling circuit,
wherein, when the main controlling circuit transmit second print data to the n-th sub-controlling circuit via the second communication path, the sub-controlling circuit group transfers the second print data in a reverse direction from the n-th sub-controlling circuit to the first controlling circuit, and
wherein the sub-controlling circuit group controls driving of the head group based on the first print data and the second print data.

2. The printing apparatus according to claim 1,
wherein the first print data includes half of data for one line of data, and
wherein the second print data includes remaining half of the data for the one line of data.

3. The printing apparatus according to claim 1,
wherein each of the first print data and the second print data is compressed data, and
wherein amount of the first data and amount of the second data are equal.

4. The printing apparatus according to claim 1,
wherein the head group includes multiple heads, and
wherein data to drive a particular head among the multiple heads is assigned to the first print data and data to drive an other head among the multiple heads is assigned to the second print data in such a manner that difference in data amount between the first print data and second print data is minimized.

5. The printing apparatus according to claim 1,
wherein the head group is configured to eject liquid on a printing medium;
wherein the printing medium has a first area and a second area wider than the first area, and
wherein print data to print on the first area and print data to print on a part of the second area are assigned to the first data, and print data to print on a remaining part of the second area is assigned to the second data in such a manner that amount of the first data and amount of the second print data are equal.

6. The printing apparatus according to claim 1,
wherein the first print data and the second data include different color print data.

7. The printing apparatus according to claim 6,
wherein the head group includes multiple heads,
wherein each of the multiple heads includes a nozzle configured to eject black ink, a nozzle configured to eject yellow ink, a nozzle configured to eject magenta ink, and a nozzle configured to eject cyan ink,
wherein the first print data includes black print data, and
wherein the second print data includes yellow print data, magenta print data and cyan print data.

8. The printing apparatus according to claim 6,
wherein the head group includes multiple heads,
wherein each of the multiple head includes a nozzle configured to eject white ink, a nozzle configured to eject black ink, a nozzle configured to eject yellow ink, a nozzle configured to eject magenta ink, and a nozzle configured to eject cyan ink,
wherein the first print data includes white print data, and
wherein the second print data includes black print data, yellow print data, magenta print data and cyan print data.

9. The printing apparatus according to claim 6,
wherein the head group includes multiple heads,
wherein each of the multiple head includes a nozzle configured to eject ink of a first color, a nozzle configured to eject ink a second color, a nozzle configured to eject ink of a third color, and a nozzle configured to eject ink of a fourth color,
wherein the first print data includes print data for the first color and print data for the second color, and
wherein the second print data includes print data for the third color and print data for the fourth color.

10. The printing apparatus according to claim 6,
wherein the main controlling circuit is configured to perform:
determining whether transferring of the first print data in the forward direction has been completed; and
determining whether transferring of the second print data in the reverse direction has been completed,
wherein, when determining that transferring of the first print data in the forward direction has been completed and determining that transferring of the second print data in the reverse direction has not been completed:
the main controlling circuit is configured to transmit the second print data to the sub-controlling circuit group via the first communication path; and
the sub-controlling circuit group is configured to transfer the second data in the forward direction, and
wherein, when determining that transferring of the first print data in the forward direction has not been completed and determining that transferring of the second print data in the reverse direction has been completed:
the main controlling circuit is configured to transmit the first print data to the sub-controlling circuit group via the second communication path; and
the sub-controlling circuit group is configured to transfer the first data in the reverse direction.

11. The printing apparatus according to claim 1
wherein the second print data includes the same data as the first print data,
wherein the main controlling circuit is configured to perform:
transmitting the first print data to the sub-controlling circuit group in the forward direction;
determining whether a retransmission request has been received from one of the first-n-th sub-controlling circuits,
wherein, when determining that the retransmission request has been received from one of the first-n-th sub-controlling circuits:
the main controlling circuit is configured to transmit the second print data to the sub-controlling circuit group via the second communication path,
the sub-controlling circuit group is configured to transfer the second print data in the reverse direction until the one of the first-n-th sub-controlling circuits receives the second print data.

12. The printing apparatus according to claim 1
wherein the second print data includes the same data as the first print data,
wherein the main controlling circuit is configured to perform:
transmitting the first print data to the sub-controlling circuit group in the reverse direction;
determining whether a retransmission request has been received from one of the first-n-th sub-controlling circuits,
wherein, when determining that the retransmission request has been received from one of the first-n-th sub-controlling circuits:
the main controlling circuit is configured to transmit the second print data to the sub-controlling circuit group via the first communication path,
the sub-controlling circuit group is configured to transfer the second print data in the forward direction until the one of the first-n-th sub-controlling circuits receives the second print data.

13. The printing apparatus according to claim 1, further comprising multiple scanners configured to scan an image formed on a printing medium by the head group,
wherein data indicating the image scanned by the multiple scanners are transferred, by the first-n-th sub-controlling circuits, separately in the forward direction and the reverse direction.

14. The printing apparatus according to claim 13,
wherein the multiple scanners are aligned in series along the sub-controlling circuit group,
wherein the number of the scanners is even, and
wherein the first-n-th sub-controlling circuits transfer data indicating an image scanned by one of adjacent scanners among the multiple scanners in the forward direction, and
wherein the first-n-th sub-controlling circuits transfer data indicating an image scanned by the other of the adjacent scanners among the multiple scanners in the reverse direction.

15. The printing apparatus according to claim 14,
wherein the multiple scanners are aligned in series along the sub-controlling circuit group,
wherein the number of the scanners is odd,
wherein the number of the scanners is odd, and
wherein the first-n-th sub-controlling circuits transfer data indicating an image scanned by one of adjacent scanners among the multiple scanners in the forward direction, and
wherein the first-n-th sub-controlling circuits transfer data indicating an image scanned by the other of the adjacent scanners among the multiple scanners in the reverse direction.

16. The printing apparatus according to claim 1,
wherein the first print data includes plurality of pieces of data associated with the first-n-th sub-controlling circuits, respectively,
wherein the second print data includes plurality of pieces of data associated with the first-n-th sub-controlling circuits, respectively,
wherein, when receiving data from upstream in the forward direction, each sub-controlling circuit of the first-(n−1)-th sub-controlling circuits is configured to obtain data associated with the each sub-controlling circuit from the received data from upstream in the forward direction, delete the obtained data associated with the each sub-controlling circuit from the received data, and transfer the received data with the obtained data deleted to downstream in the forward direction,
wherein, when receiving data from upstream in the forward direction, the n-th sub-controlling circuit is configured to obtain data associated with the n-th sub-controlling circuit, wherein, when receiving data from upstream in the reverse direction, each sub-controlling circuit of the n-th-second sub-controlling circuits is configured to obtain data associated with the each sub-controlling circuit from the received data from upstream in the reverse direction,
wherein, after obtaining the data associated with the each sub-controlling circuit of the n-th-second sub-controlling circuits from the received data from upstream in the reverse direction, the each sub-controlling circuit of the n-th-second sub-controlling circuits is configured to delete the obtained data associated with the each sub-controlling circuit from the received data,
wherein, after deleting the obtained data associated with the each sub-controlling circuit from the received data, the each sub-controlling circuit of the n-th-second sub-controlling circuits is configured to transfer the received data with the obtained data deleted to downstream in the reverse direction, and
wherein, when receiving data from upstream in the reverse direction, the first sub-controlling circuit is configured to obtain data associated with the first sub-controlling circuit.

17. A printing method for a printing apparatus having a main controlling circuit, a sub-controlling circuit group including first-n-th sub-controlling circuits connected in series, n being integer equal to or more than two, a head group configured to be controlled by the sub-controlling circuit group, the head group is configured to eject liquid, a first communication path configured to connect the main controlling circuit and the first sub-controlling circuit, and a second communication path configured to connect the main controlling circuit and the n-th sub-controlling circuit,
wherein the printing method comprising:
when the main controlling circuit transmit first print data to the first sub-controlling circuit via the first communication path, the sub-controlling circuit group transferring the first print data in a forward direction from the first sub-controlling circuit to the n-th controlling circuit,
when the main controlling circuit transmit second print data to the n-th sub-controlling circuit via the second communication path, the sub-controlling circuit group transferring the second print data in a reverse direction from the n-th sub-controlling circuit to the first controlling circuit; and
the sub-controlling circuit group controlling driving of the head group based on the first print data and the second print data.

18. A non-transitory computer-readable recording medium for a printing apparatus having a main controlling circuit, a sub-controlling circuit group including first-n-th sub-controlling circuits connected in series, n being integer equal to or more than two, a head group configured to be controlled by the sub-controlling circuit group, the head group is configured to eject liquid, a first communication path configured to connect the main controlling circuit and the first sub-controlling circuit, and a second communication path configured to connect the main controlling circuit and the n-th sub-controlling circuit,
wherein the non-transitory computer-readable recording medium containing computer-executable instructions which cause, when executed by a controller of the printing apparatus, the printing apparatus to perform:
when the main controlling circuit transmit first print data to the first sub-controlling circuit via the first communication path, causing the sub-controlling circuit group to transfer the first print data in a forward direction from the first sub-controlling circuit to the n-th controlling circuit,
when the main controlling circuit transmit second print data to the n-th sub-controlling circuit via the second communication path, causing the sub-controlling circuit group to transfer the second print data in a reverse direction from the n-th sub-controlling circuit to the first controlling circuit; and
causing the sub-controlling circuit group to control driving of the head group based on the first print data and the second print data.
